(19) United States
(12) Patent Application Publication
(10) Pub. No.: US 2025/0305507 A1
(43) Pub. Date: Oct. 2, 2025

(54) IMPELLER AND MAGNETIC LEVITATION TYPE PUMP

(71) Applicant: PILLAR Corporation, Osaka (JP)

(72) Inventors: Shingo Higuchi, Osaka (JP); Kento Nakagawa, Osaka (JP)

(73) Assignee: PILLAR Corporation, Osaka (JP)

(21) Appl. No.: 19/093,635

(22) Filed: Mar. 28, 2025

(30) Foreign Application Priority Data
Mar. 29, 2024 (JP) 2024-055702

(51) Int. Cl. F04D 29/048; F04D 1/00; F04D 13/06; F04D 29/66

(52) U.S. Cl. CPC F04D 29/048; F04D 13/06; F04D 29/66; F04D 1/00

(57) ABSTRACT

An impeller of the present disclosure includes: an impeller body having a plurality of balance holes; a plurality of vanes provided on an end surface of the impeller body; and a cover plate having an inlet for a transport fluid. The end surface of the impeller body has a plurality of flow path surfaces each located between the vanes, and a contact surface that is located radially inward of the plurality of vanes and that is for causing the transport fluid that has flowed in through the inlet to contact the contact surface and guiding the transport fluid to each of the flow path surfaces, and an opening on one side in an axial direction of each of the balance holes is located at least either within or outside a range of the inlet when the impeller is viewed from the one side in the axial direction.

### TECHNICAL FIELD

The present disclosure relates to an impeller and a magnetic levitation type pump. This application claims priority on Japanese Patent Application No. 2024-055702 filed on Mar. 29, 2024, the entire content of which is incorporated herein by reference.

### BACKGROUND ART

A magnetic levitation type pump rotates an impeller relative to a housing while levitating the impeller with magnetism and supporting the impeller in a non-contact manner. If the impeller moves in the axial direction during rotation, the impeller may come into contact with the housing and be damaged. Therefore, the impeller of the magnetic levitation type pump requires a mechanism that, when the impeller moves toward one side in the axial direction, applies a position restoring force to push the impeller back toward the other side in the axial direction (see, for example, FIG. 2 of PATENT LITERATURE 1).

The impeller (rotor) of a magnetic levitation type pump described in PATENT LITERATURE 1 includes an impeller body having a plurality of balance holes (relief bores), a partition plate (partition element) having a circular plate shape, and a plurality of vanes fixed to the outer circumference of the partition plate. Each vane has a first vane portion (first vane) above the partition plate and a second vane portion (second vane) below the partition plate.

Above the partition plate, the first vane portion generates a main flow in which a transport fluid flows from an inlet to an outlet of the housing, due to the centrifugal force generated by the rotation of the impeller. Due to this main flow, a load by which the impeller is pulled toward the upper side in the axial direction acts on the impeller. Below the partition plate, the second vane portion generates a circulation flow in which the transport fluid that has flowed from the upper side to the lower side on the outer side in the radial direction of the impeller body flows from the lower side to the upper side on the radially inner side of the impeller body (in the balance holes). Due to this circulation flow, a reverse load by which the impeller is pulled toward the lower side in the axial direction acts on the impeller.

During operation of the magnetic levitation type pump, the impeller is held at a predetermined position in the axial direction by balancing between the load toward the upper side in the axial direction and the reverse load toward the lower side in the axial direction. If the impeller is moved toward the lower side in the axial direction by an external force from this state, the flow rate of the circulation flow decreases and the reverse load toward the lower side in the axial direction decreases. Accordingly, the load toward the upper side in the axial direction dominantly acts on the impeller as a position restoring force. Conversely, if the impeller is moved toward the upper side in the axial direction by an external force, the flow rate of the circulation flow increases and the reverse load toward the lower side in the axial direction increases. Accordingly, the reverse load dominantly acts on the impeller as a position restoring force. These position restoring forces restrict the impeller from moving from the predetermined position toward both sides in the axial direction.

### CITATION LIST

### Patent Literature

PATENT LITERATURE 1: U.S. Pat. No. 9,115,725

### SUMMARY OF THE INVENTION

### Technical Problem

In addition to the impeller body and the vanes, the impeller of the above magnetic levitation type pump includes the partition plate that separates the main flow and the circulation flow and causes the position restoring forces in the axial direction to act on the impeller. Therefore, there is a problem that the number of components is increased and the cost of manufacturing the impeller is increased.

The present disclosure has been made in view of such circumstances, and an object of the present disclosure is to provide a technology capable of manufacturing, at low cost, an impeller on which a position restoring force in an axial direction acts.

### Solution to Problem

(1) The present disclosure is directed to an impeller including: an impeller body having a circular column shape and having a plurality of balance holes formed therein so as to penetrate the impeller in an axial direction; a plurality of vanes provided at an interval in a circumferential direction on an end surface on one side in the axial direction of the impeller body; and a cover plate provided on the one side in the axial direction of the plurality of vanes and having an inlet for a transport fluid formed in a center portion thereof, wherein, when the impeller rotates around an axis, the transport fluid that has flowed in through the inlet is caused to flow outward in a radial direction from between the vanes adjacent to each other in the circumferential direction, the end surface of the impeller body has a plurality of flow path surfaces each located between the vanes adjacent to each other in the circumferential direction, and a contact surface that is located radially inward of the plurality of vanes so as to be connected to the plurality of flow path surfaces and that is for causing the transport fluid that has flowed in through the inlet to contact the contact surface and guiding the transport fluid to each of the flow path surfaces, and an opening on the one side in the axial direction of each of the balance holes is located at least either within or outside a range of the inlet when the impeller is viewed from the one side in the axial direction.

The inventor of the present application has conducted thorough research. As a result, the inventor has found that even if an impeller does not include a partition plate, a position restoring force in the axial direction acts on the impeller, and based on this finding, the inventor has completed the impeller in (1) above.

Specifically, with the impeller of the present disclosure, when the impeller body is rotated, the transport fluid that has flowed in through the inlet of the cover plate contacts the contact surface on the one side in the axial direction of the impeller body, whereby a main flow in which the transport fluid flows outward in the radial direction along the plurality of flow path surfaces, which are connected to the contact surface, occurs. Due to this main flow, a load by which the impeller is pulled toward the one side in the axial direction acts on the impeller. In addition, a circulation flow, in which a part of the transport fluid that has flowed to the outer side in the radial direction of the impeller flows around the other side in the axial direction of the impeller body, passes through the inside of each balance hole, and flows to the one side in the axial direction of the impeller body, occurs. Due to this circulation flow, a reverse load by which the impeller is pulled toward the other side in the axial direction acts on the impeller. Therefore, even with the impeller in which a conventional partition plate is not used, one of the load and the reverse load acts on the impeller as a position restoring force in the axial direction, so that it is possible to manufacture, at low cost, the impeller on which a position restoring force in the axial direction acts.

(2) In the impeller in (1) above, preferably, the inlet is a circular hole formed so as to be centered at the axis, and when a radius of the inlet is denoted by R and a distance from a center of gravity of the opening to the axis in at least one of the plurality of balance holes is denoted by L, a relationship of L/R>0.763 is satisfied.

The inventor of the present application has further conducted thorough research. As a result, the inventor has found that when the radius R of the inlet of the cover plate and the distance L from the center of gravity of the opening of each balance hole to the axis of the impeller body satisfy the relationship of L/R>0.763, the impeller is held at an appropriate position in the axial direction by the position restoring force, and based on this finding, the inventor has completed the impeller in (2) above. With this impeller, it is possible to hold the impeller at the appropriate position in the axial direction by the position restoring force, so that it is possible to effectively inhibit the impeller from colliding with another member and being damaged, while reducing the pressure loss of the transport fluid.

(3) In the impeller in (1) or (2) above, preferably, the opening is formed in an arc shape centered at the axis when the balance hole is viewed from the one side in the axial direction.

In this case, since the opening of each balance hole is formed in an arc shape, the opening is longer in the circumferential direction than that in the case of being formed in a circular shape having the same opening area as this arc shape. Accordingly, the width in the circumferential direction of the circulation flow, in which the transport fluid flows out of the opening of each balance hole and flows to each flow path surface on the outer side in the radial direction, becomes longer, so that the main flow and the circulation flow can be caused to meet evenly in the circumferential direction. As a result, the transport fluid is less likely to stay in the region where the main flow and the circulation flow meet, so that the transport fluid can be more efficiently caused to flow toward the outer side in the radial direction.

(4) A magnetic levitation type pump of the present disclosure includes: a housing having a suction port and a discharge port for a transport fluid; the impeller in any one of (1) to (3) above, placed in the housing; a motor configured to rotationally drive the impeller; and a magnetic bearing supporting the impeller that is rotating, in a non-contact manner.

With the above magnetic levitation type pump, the same advantageous effects as those of the above impeller are achieved. In addition, no pressure loss of the transport fluid due to a conventional partition plate is generated, so that it is possible to improve the performance of transporting the transport fluid by the magnetic levitation type pump.

### Advantageous Effects of the Invention

According to the present disclosure, it is possible to manufacture, at low cost, an impeller on which a position restoring force in an axial direction acts.

### BRIEF DESCRIPTION OF DRAWINGS

FIG. 1 is a schematic cross-sectional view showing a magnetic levitation type pump according to an embodiment of the present disclosure.

FIG. 2 is an enlarged cross-sectional view showing an impeller of the magnetic levitation type pump.

FIG. 3 shows a cross-section as viewed in the direction of arrows I-I in FIG. 1.

FIG. 4 is an enlarged view of a main part in FIG. 3, showing a balance hole of an impeller body.

FIG. 5 illustrates Verification Test 1.

FIG. 6 is a graph showing the results of Verification Test 1.

FIG. 7 is a table showing the results of Verification Test 2.

### DETAILED DESCRIPTION

Next, a preferred embodiment will be described with reference to the accompanying drawings.

### [Entire Configuration]

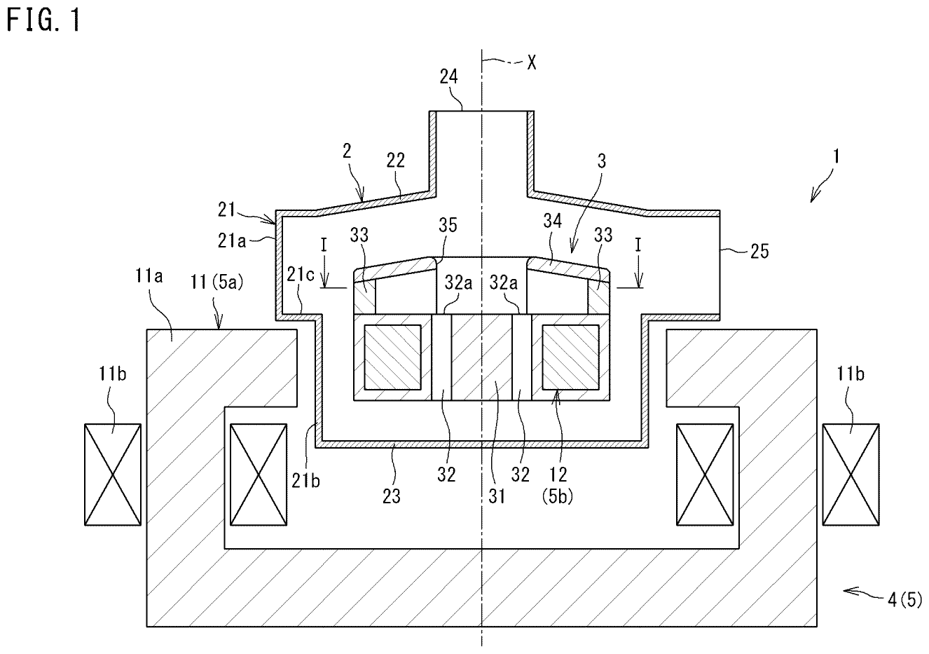

FIG. 1 is a schematic cross-sectional view showing a magnetic levitation type pump 1 according to an embodiment of the present disclosure. In FIG. 1, the magnetic levitation type pump 1 of the present embodiment (hereinafter also simply referred to as “pump 1”) is composed of a centrifugal pump. The pump 1 includes a housing 2, an impeller 3, a motor 4, and a magnetic bearing 5.

In the present disclosure, a direction along an axis X of the pump 1 is the axial direction of the pump 1 and is simply referred to as “axial direction” below. In addition, a direction orthogonal to the axis X is the radial direction of the pump 1 and is simply referred to as “radial direction” below. The direction of rotation around the axis X is the circumferential direction of the pump 1 and is simply referred to as “circumferential direction” below.

The housing 2 has a housing body 21, a top wall 22, and a bottom wall 23. The housing body 21 has a first cylindrical portion 21a and a second cylindrical portion 21b that are formed in a cylindrical shape centered at the axis X, and an annular portion 21c that connects the first cylindrical portion 21a and the second cylindrical portion 21b. The first cylindrical portion 21a is formed on the upper side in the axial direction (one side in the axial direction, the same applies below) of the housing body 21. The second cylindrical portion 21b has a smaller diameter than the first cylindrical portion 21a and is formed on the lower side in the axial direction (the other side in the axial direction, the same applies below) of the housing body 21. The outer circumferential edge of the annular portion 21c is connected to an end portion on the lower side in the axial direction of the first cylindrical portion 21a. The inner circumferential edge of the annular portion 21c is connected to an end portion on the upper side in the axial direction of the second cylindrical portion 21b.

The top wall 22 is formed in a substantially conical plate shape and closes the opening on the upper side in the axial direction of the first cylindrical portion 21a. The bottom wall 23 is formed in a disc shape and closes the opening on the lower side in the axial direction of the second cylindrical portion 21b. The housing 2 further has a suction port 24 through which a transport fluid is sucked, and a discharge port 25 through which the transport fluid is discharged. The suction port 24 is formed in a center portion of the top wall 22. The discharge port 25 is formed at a predetermined location in the circumferential direction in the first cylindrical portion 21a.

The impeller 3 is placed in the housing 2 so as to be rotatable around the axis X. When the impeller 3 rotates, the transport fluid is sucked into the housing 2 through the suction port 24, and is discharged through the discharge port 25 to the outside of the housing 2 by a centrifugal force. The impeller 3 will be described in detail later.

The motor 4 rotationally drives the impeller 3. The motor 4 has a stator 11 that is placed outside the housing 2, and a rotor 12 that is provided to the impeller 3. The stator 11 has a fixed magnetic portion 11a that is composed of a magnetic material such as iron, and a winding 11b that is wound around the fixed magnetic portion 11a. The rotor 12 is provided within the impeller 3. The material of the rotor 12 is composed of at least one of a permanent magnet, a magnetic material such as iron, and a conductor such as copper. When operating the pump 1, a current is applied to the winding 11b of the stator 11. Accordingly, a rotating magnetic field is generated, whereby the rotor 12 rotates around the axis X together with the impeller 3.

The magnetic bearing 5 supports the impeller 3 that is rotating, in a non-contact manner. The magnetic bearing 5 has a magnetic support portion Sa that is placed outside the housing 2, and a supported portion 5b that is provided to the impeller 3. In the present embodiment, the motor 4 also serves as the magnetic bearing 5. Specifically, the stator 11 of the motor 4 also serves as the magnetic support portion 5a, and the rotor 12 of the motor 4 also serves as the supported portion 5b. The impeller 3 rotates while being supported in a non-contact manner due to magnetism generated from the magnetic support portion 5a to the supported portion 5b. The magnetic bearing 5 may be provided separately from the motor 4.

### [Impeller]

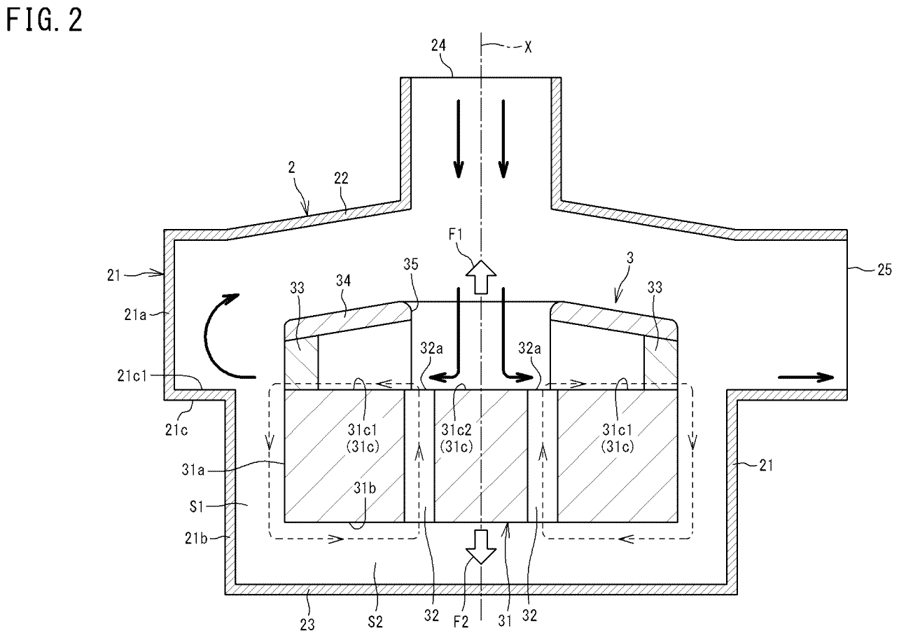

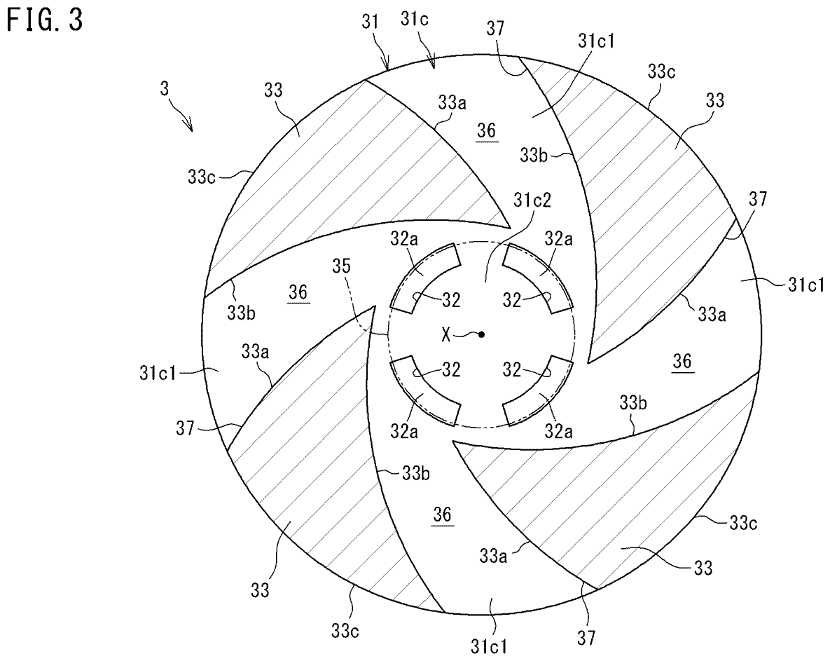

FIG. 2 is an enlarged cross-sectional view showing the impeller 3. In FIG. 2, the rotor 12 of the motor 4 is not shown. FIG. 3 shows a cross-section as viewed in the direction of arrows I-I in FIG. 1. In FIG. 2 and FIG. 3, the impeller 3 has an impeller body 31, a plurality of (four in FIG. 3) vanes 33, and a cover plate 34.

The impeller body 31 is formed in a circular column shape centered at the axis X. Within the impeller body 31, the rotor 12 is provided (see FIG. 1). In a state where the impeller 3 is supported in a non-contact manner by the magnetic bearing 5, an annular first space S1 is formed between an outer circumferential surface 31a of the impeller body 31 and the inner circumferential surface of the second cylindrical portion 21b of the housing body 21. In addition, in a state where the impeller 3 is supported in a non-contact manner, a second space S2 is formed between an end surface 31b on the lower side in the axial direction of the impeller body 31 and the bottom wall 23.

The plurality of vanes 33 are provided at equal intervals in the circumferential direction on an end surface 31c on the upper side in the axial direction of the impeller body 31. Each vane 33 is formed, for example, in a substantially triangular shape in a plan view seen from the upper side in the axial direction. Each vane 33 has a first side surface 33a, a second side surface 33b, and an outer surface 33c.

The first side surface 33a and the second side surface 33b of each vane 33 are surfaces perpendicular to the end surface 31c of the impeller body 31 and extend while curving from the inner side in the radial direction toward the outer end in the radial direction of the impeller body 31. The outer surface 33c of each vane 33 is an arc surface having the same radius of curvature as the outer circumferential surface 31a of the impeller body 31. The shape of each vane 33 is not limited to the shape in the present embodiment.

The cover plate 34 is provided on the upper side in the axial direction of the plurality of vanes 33 so as to cover these vanes 33. The cover plate 34 of the present embodiment is fixed to the end surface on the upper side in the axial direction of each vane 33. The cover plate 34 is formed, for example, in a circular shape centered at the axis X. The outer diameter of the cover plate 34 is the same as the outer diameter of the impeller body 31. In a center portion of the cover plate 34, an inlet 35 through which the transport fluid flows into the impeller 3 is formed. The inlet 35 is formed radially inward of the plurality of vanes 33. The inlet 35 of the present embodiment is a circular hole formed so as to be centered at the axis X. The inlet 35 may have a shape other than a circular hole. In addition, the inlet 35 may be formed with a size that allows radially inner end portions of the plurality of vanes 33 to be seen when the impeller 3 is viewed from the upper side in the axial direction.

The end surface 31c on the upper side in the axial direction of the impeller body 31 has a plurality of (four in FIG. 3) flow path surfaces 31c1 each located between the vanes 33 adjacent to each other in the circumferential direction, and a contact surface 31c2 located radially inward of the plurality of vanes 33. In a center portion of the end surface 31c, the contact surface 31c2 is formed in a circular shape centered at the axis X. The radially outer end of the contact surface 31c2 is connected to the plurality of flow path surfaces 31c1.

Each flow path surface 31c1 extends in the radial direction while curving when viewed from the upper side in the axial direction. The transport fluid that has flowed into the impeller 3 through the inlet 35 directly contacts the contact surface 31c2. The transport fluid that has contacted the contact surface 31c2 is radially divided along the contact surface 31c2 and guided to each flow path surface 31c1.

Between each flow path surface 31c1 of the impeller body 31 and the cover plate 34, a flow path 36 in which the transport fluid in the impeller 3 flows from the inner side in the radial direction toward the outer side in the radial direction along each flow path surface 31c1 is formed between the vanes 33 adjacent to each other in the circumferential direction. The opening on the outer side in the radial direction of each flow path 36 is an outlet 37 through which the transport fluid flows out of the impeller 3. Therefore, a plurality of outlets 37 through which the transport fluid flows out of the impeller 3 are formed at the outer circumference of the impeller 3.

### [Balance Holes]

A plurality of balance holes 32 are formed radially inward of the rotor 12 (see FIG. 1) in the impeller body 31 so as to penetrate the impeller body 31 in the axial direction. In the impeller body 31 of the present embodiment, four balance holes 32 are formed at equal intervals in the circumferential direction around the axis X. Each of openings 32a on the upper side in the axial direction of the plurality of balance holes 32 is located radially inward of each flow path surface 31c1 and radially outward of the contact surface 31c2. A part of the transport fluid flows through the balance hole 32 from the lower side in the axial direction toward the upper side in the axial direction.

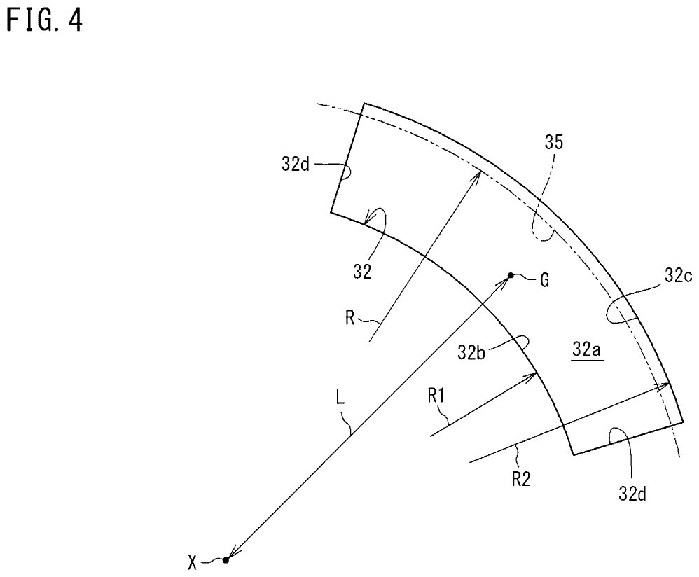

FIG. 4 is an enlarged view of a main part in FIG. 3, showing the balance hole 32. In FIG. 3 and FIG. 4, the opening 32a of each balance hole 32 is formed, for example, in an arc shape as viewed in the axial direction. Each balance hole 32 has an inner arc surface 32b and an outer arc surface 32c that are formed so as to be centered at the axis X, and a pair of side surfaces 32d that extend in the radial direction. A radius of curvature R1 of the inner arc surface 32b of each balance hole 32 is smaller than a radius R of the inlet 35. A radius of curvature R2 of the outer arc surface 32c of each balance hole 32 is larger than the radius R of the inlet 35. Therefore, in the present embodiment, the opening 32a of each balance hole 32 is located both within the range of the inlet 35 (within a circle with the radius R) and outside the range of the inlet 35 (outside the circle with the radius R) when the impeller 3 is viewed from the upper side in the axial direction. Each balance hole 32 is formed in the same arc shape as the opening 32a over the entirety in the axial direction thereof.

The opening 32a of each balance hole 32 may be located on the inner side in the radial direction of the flow path surface 31c1 or may be located both on the inner side in the radial direction of the flow path surface 31c1 and on the outer side in the radial direction of the contact surface 31c2. In addition, when the impeller 3 is viewed from the upper side in the axial direction, the opening 32a of each balance hole 32 may be located only within the range of the inlet 35 or may be located only outside the range of the inlet 35. Moreover, the shape of each balance hole 32 is not limited to the shape in the present embodiment, and may be formed, for example, in a circular shape as viewed in the axial direction. In addition, the number of balance holes 32 is not limited to the number in the present embodiment.

### [Flow of Transport Fluid]

In FIG. 2 and FIG. 3, when the pump 1 is operated and the impeller 3 rotates around the axis X, the transport fluid is sucked through the suction port 24 of the housing 2 and flows into the impeller 3 through the inlet 35 of the impeller 3. The transport fluid that has flowed into the impeller 3 contacts the contact surface 31c2 of the impeller body 31, is radially divided, and flows toward the outer side in the radial direction along the contact surface 31c2 due to the centrifugal force generated by the rotation of the impeller 3.

Accordingly, the transport fluid flows into each flow path 36 between the vanes 33 adjacent to each other, further flows toward the outer side in the radial direction along each flow path surface 31c1 of the impeller body 31, and flows to the outer side in the radial direction of the impeller 3 through each outlet 37. Most of the transport fluid that has flowed out of the impeller 3 is discharged to the outside of the housing 2 through the discharge port 25 of the housing 2. Therefore, within the impeller 3 that is rotating, a flow of the transport fluid from the suction port 24 to the discharge port 25 of the housing 2 occurs. Hereinafter, this flow is referred to as “main flow”.

The remaining part of the transport fluid that has flowed out of the impeller 3 passes through the first space S1 and the second space S2 in the housing 2 in this order, and flows into each balance hole 32 from the lower side in the axial direction of the impeller body 31. The transport fluid that has flowed into each balance hole 32 flows into the upper side in the axial direction of the impeller body 31 through the opening 32a of each balance hole 32. The transport fluid that has flowed into the upper side in the axial direction of the impeller body 31 flows outward in the radial direction due to the above centrifugal force, and flows out of the impeller 3 again. Therefore, in the housing 2, a flow in which the transport fluid circulates between the inner side in the radial direction (balance holes 32) and the outer side in the radial direction (first space S1) of the impeller body 31, occurs. Hereinafter, this flow is referred to as “circulation flow”.

### [Position Restoring Force]

On the impeller 3, a load F1 by which the impeller 3 is pulled toward the upper side in the axial direction, acts due to the main flow. Specifically, in the middle of the main flow, the transport fluid flows from the inner side in the radial direction toward the outer side in the radial direction along the end surface 31c on the upper side in the axial direction (contact surface 31c2) of the impeller body 31, whereby negative pressure is generated at the center portion of the end surface 31c of the impeller body 31. Due to the negative pressure, the load F1 toward the upper side in the axial direction acts on the impeller 3. Hereinafter, this load F1 is also referred to as “upward load F1”.

On the impeller 3, a load F2 by which the impeller 3 is pulled toward the lower side in the axial direction, acts due to the circulation flow. Specifically, in the middle of the circulation flow, the transport fluid flows into each balance hole 32 from the lower side in the axial direction (second space S2) of the impeller body 31, whereby negative pressure is generated at the center portion of the end surface 31b on the lower side in the axial direction of the impeller body 31. Due to this negative pressure, the load F2 toward the lower side in the axial direction acts on the impeller 3. Hereinafter, this load F2 is also referred to as “downward load F2”.

During operation of the pump 1, the impeller 3 is held at a predetermined position in the axial direction by balancing between the upward load F1 and the downward load F2. The predetermined position in the axial direction is preferably an appropriate position. The appropriate position is a position at which the end surface 31c on the upper side in the axial direction of the impeller body 31 is flush with an inner surface 21c1 on the upper side in the axial direction of the annular portion 21c of the housing body 21 as shown in FIG. 2 and the pressure loss of the transport fluid can be reduced to the greatest extent.

If the impeller 3 is moved toward the lower side in the axial direction by an external force from the balanced state of both loads F1 and F2, the second space S2 becomes narrower, resulting in a reduction in the flow rate of the circulation flow. Accordingly, the downward load F2 becomes smaller, so that the upward load F1 more dominantly acts on the impeller 3 than the downward load F2 does. Therefore, the impeller 3 moved toward the lower side in the axial direction is pushed back upward in the axial direction toward the predetermined position by the upward load F1 acting thereon as a position restoring force.

On the other hand, if the impeller 3 is moved toward the upper side in the axial direction by an external force from the balanced state of both loads F1 and F2, the second space S2 becomes wider, resulting in an increase in the flow rate of the circulation flow. Accordingly, the downward load F2 becomes larger, so that the downward load F2 more dominantly acts on the impeller 3 than the upward load F1 does. Therefore, the impeller 3 moved toward the upper side in the axial direction is pushed back downward in the axial direction toward the predetermined position by the downward load F2 acting thereon as a position restoring force. Due to the above, either the upward load F1 or the downward load F2 acts on the impeller 3 as a position restoring force in the axial direction.

In FIG. 3 and FIG. 4, in order to hold the impeller 3 at the appropriate position in the axial direction by the position restoring force, it is preferable that each balance hole 32 and the inlet 35 satisfy a relationship of the following formula (1).

$$L / R > 0.763 \qquad ( 1 )$$

L denotes the distance from a center of gravity G of the opening 32a of each balance hole 32 to the axis X. The “center of gravity of the opening 32a” means the center of gravity of the shape of the opening 32a when the balance hole 32 is viewed from the upper side in the axial direction (one side in the axial direction). R denotes the radius of the inlet 35. It is sufficient that at least one of the plurality of balance holes 32 satisfies the relationship of the above formula (1).

### [Verification Test 1]

Verification Test 1 was conducted as to whether or not the position restoring force in the axial direction appropriately acts on the impeller 3 if each balance hole 32 of the impeller body 31 is located at each of the following P1, P2, and P3 when the impeller 3 is viewed from the upper side in the axial direction.

P1: each balance hole 32 is located only outside the range of the inlet 35.

P2: each balance hole 32 is located within and outside the range of the inlet 35 (present embodiment).

P3: each balance hole 32 is located only within the range of the inlet 35.

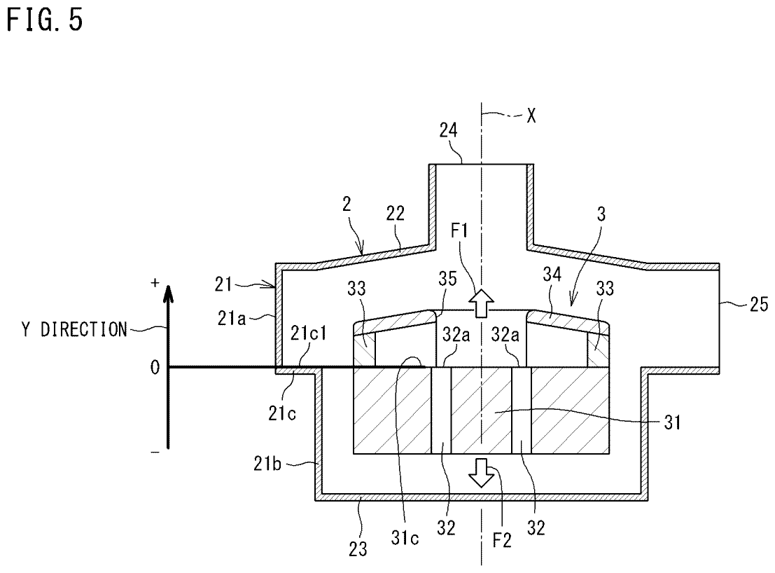

FIG. 5 illustrates Verification Test 1. In Verification Test 1, in each of the cases of P1 to P3, a load (position restoring force) in a Y direction (axial direction) acting on the rotating impeller 3 when the impeller 3 was displaced in a range from −5 mm to +1 mm relative to an origin in the Y direction was calculated by fluid analysis software. The origin in the Y direction was defined as a position on the end surface 31c on the upper side in the axial direction of the impeller body 31 at the appropriate position as shown in FIG. 5. The range (−5 mm to +1 mm) in which the impeller 3 is displaced in the Y direction during this test is a range where the impeller 3 does not collide with the top wall 22 and the bottom wall 23 of the housing 2. In all the cases of P1 to P3, the same condition was set for the flow rate of the transport fluid.

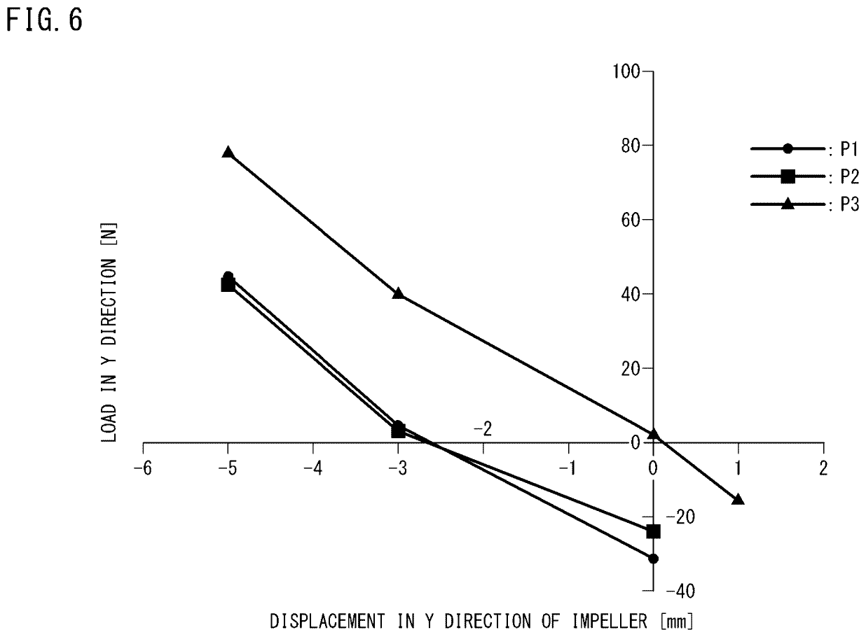

FIG. 6 is a graph showing the results of Verification Test 1. As shown in FIG. 6, in all the cases of P1 to P3, a state where the load in the Y direction acting on the impeller 3 becomes zero, that is, a state where the upward load F1 on the positive side in the Y direction and the downward load F2 on the negative side in the Y direction are balanced, occurs within the range in which the impeller 3 is displaced in the Y direction. Therefore, it is confirmed that, in all the cases of P1 to P3, the position restoring force appropriately acts on the impeller 3 such that the impeller 3 does not collide with the housing 2.

### [Verification Test 2]

Next, Verification Test 2 was conducted as to whether or not the impeller 3 can be held at the appropriate position in the axial direction by the position restoring force when each balance hole 32 and the inlet 35 of the present embodiment satisfy the relationship of the above formula (1). In Verification Test 2, the load (position restoring force) in the Y direction acting on the impeller 3 when the value of L/R was changed in a state where the impeller 3 was fixed at the appropriate position (Y=0 mm) in FIG. 5 was calculated by fluid analysis software. In this test as well, the same condition was set for the flow rate of the transport fluid when the value of L/R was changed.

In the pump 1 of the present embodiment, due to the structure of the centrifugal pump, the upward load F1 is larger than the downward load F2, so that the impeller 3 moves toward the upper side in the axial direction from the appropriate position. Therefore, it is sufficient that the downward load F2 acts as a position restoring force on the impeller 3 moving toward the upper side in the axial direction. That is, it can be considered that if the load in the Y direction has a negative value, the downward load F2 acts as a position restoring force, whereby the upward load F1 and the downward load F2 can be balanced and the impeller 3 can be held at the appropriate position.

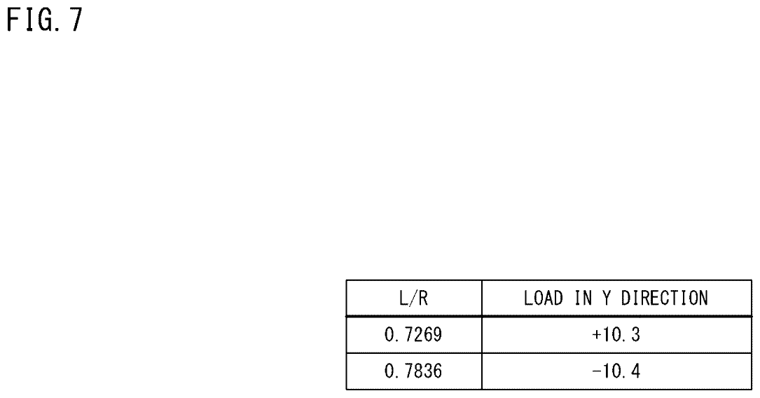

FIG. 7 is a table showing the results of Verification Test 2. As shown in FIG. 7, when L/R is 0.7629, that is, when L/R<0.763, the load in the Y direction has a positive value. In contrast, when L/R is 0.7836, that is, when L/R>0.763, the load in the Y direction has a negative value. Therefore, it is confirmed that when the relationship of the above formula (1) is satisfied, the downward load F2 (load in the Y direction having a negative value) can act as a position restoring force and the impeller 3 can be held at the appropriate position.

### Advantageous Effects

With the magnetic levitation type pump 1 and the impeller 3 of the present embodiment, when the impeller body 31 is rotated, the transport fluid that has flowed in through the inlet 35 of the cover plate 34 contacts the contact surface 31c2 on the upper side in the axial direction of the impeller body 31, whereby a main flow in which the transport fluid flows outward in the radial direction along the plurality of flow path surfaces 31c1, which are connected to the contact surface 31c2, occurs. Due to this main flow, a position restoring force by which the impeller 3 is pulled toward the upper side in the axial direction acts on the impeller 3. In addition, a circulation flow, in which a part of the transport fluid that has flowed to the outer side in the radial direction of the impeller 3 flows around the lower side in the axial direction of the impeller body 31, passes through the inside of each balance hole 32, and flows to the upper side in the axial direction of the impeller body 31, occurs. Due to this circulation flow, a position restoring force by which the impeller 3 is pulled toward the lower side in the axial direction acts on the impeller 3.

Therefore, even with the impeller 3 in which a conventional partition plate is not used, a position restoring force in the axial direction acts on the impeller 3, so that it is possible to manufacture, at low cost, the impeller 3 on which a position restoring force in the axial direction acts. In addition, no pressure loss of the transport fluid due to a conventional partition plate is generated, so that it is possible to improve the performance of transporting the transport fluid by the pump 1.

Since the radius R of the inlet 35 of the cover plate 34 and the distance L from the center of gravity G of each balance hole 32 to the axis X of the impeller body 31 satisfy the relationship of L/R>0.763, the impeller 3 can be held at the appropriate position in the axial direction by the position restoring force. Accordingly, it is possible to effectively inhibit the impeller 3 from colliding with the top wall 22 or the bottom wall 23 of the housing 2 and being damaged, while reducing the pressure loss of the transport fluid.

Since the opening 32a of each balance hole 32 is formed in an arc shape, the opening 32a is longer in the circumferential direction than that in the case of being formed in a circular shape having the same opening area as this arc shape. Accordingly, the width in the circumferential direction of the circulation flow, in which the transport fluid flows out of the opening 32a of each balance hole 32 and flows to each flow path surface 31c1 on the outer side in the radial direction, becomes longer, so that the main flow and the circulation flow can be caused to meet evenly in the circumferential direction. As a result, the transport fluid is less likely to stay in the region where the main flow and the circulation flow meet, so that the transport fluid can be efficiently caused to flow toward the outer side in the radial direction.

The opening 32a of each balance hole 32 is located both within and outside the range of the inlet 35. Accordingly, a part of the opening 32a of each balance hole 32 is located outside the range of the inlet 35, so that it is possible to reduce the region where the main flow in which the transport fluid flows into the lower side in the axial direction through the inlet 35 and the circulation flow in which the transport fluid flows out to the upper side in the axial direction through each opening 32a directly meet. As a result, the main flow can be further efficiently caused to flow toward the outer side in the radial direction. In addition, the circulation flow can be inhibited from being disturbed by the main flow.

Furthermore, since each balance hole 32 is formed in the same shape as the opening 32a over the entirety in the axial direction thereof, a part of each balance hole 32 is located within the range of the inlet 35 over the entirety in the axial direction thereof. Accordingly, the volume of the supported portion 5b (rotor 12), which is provided radially outward of the balance hole 32 in the impeller body 31, can be made larger than that in the case where the entirety of each balance hole 32 is located outside the range of the inlet 35 over the entirety in the axial direction thereof. As a result, the magnetism generated from the magnetic support portion 5a to the supported portion 5b becomes stronger, so that the impeller 3 can be supported more stably in a non-contact state by the magnetic bearing 5.

### [Others]

The embodiment disclosed herein is merely illustrative and not restrictive in all aspects. The scope of the present invention is defined by the scope of the claims rather than the meaning described above, and is intended to include meaning equivalent to the scope of the claims and all modifications within the scope.

### REFERENCE SIGNS LIST

1 magnetic levitation type pump
2 housing
3 impeller
4 motor
5 magnetic bearing
24 suction port
25 discharge port
31 impeller body
31c end surface
31c1 flow path surface
31c2 contact surface
32 balance hole
32a opening
33 vane
35 inlet
G center of gravity
X axis

1. An impeller comprising:
an impeller body having a circular column shape and having a plurality of balance holes formed therein so as to penetrate the impeller in an axial direction;
a plurality of vanes provided at an interval in a circumferential direction on an end surface on one side in the axial direction of the impeller body; and
a cover plate provided on the one side in the axial direction of the plurality of vanes and having an inlet for a transport fluid formed in a center portion thereof, wherein
when the impeller rotates around an axis, the transport fluid that has flowed in through the inlet is caused to flow outward in a radial direction from between the vanes adjacent to each other in the circumferential direction,
the end surface of the impeller body has
a plurality of flow path surfaces each located between the vanes adjacent to each other in the circumferential direction, and
a contact surface that is located radially inward of the plurality of vanes so as to be connected to the plurality of flow path surfaces and that is for causing the transport fluid that has flowed in through the inlet to contact the contact surface and guiding the transport fluid to each of the flow path surfaces, and
an opening on the one side in the axial direction of each of the balance holes is located at least either within or outside a range of the inlet when the impeller is viewed from the one side in the axial direction.

2. The impeller according to claim 1, wherein
the inlet is a circular hole formed so as to be centered at the axis, and
when a radius of the inlet is denoted by R and a distance from a center of gravity of the opening to the axis in at least one of the plurality of balance holes is denoted by L, a relationship of L/R>0.763 is satisfied.

3. The impeller according to claim 1, wherein the opening is formed in an arc shape centered at the axis when the balance hole is viewed from the one side in the axial direction.

4. A magnetic levitation type pump comprising:
a housing having a suction port and a discharge port for a transport fluid;
the impeller according to claim 1, placed in the housing;
a motor configured to rotationally drive the impeller, and
a magnetic bearing supporting the impeller that is rotating, in a non-contact manner.
